(19) United States
(12) Patent Application Publication
(10) Pub. No.: US 2007/0157280 A1
(43) Pub. Date: Jul. 5, 2007

(54) Multimedia in-band gateway

(75) Inventors: Erez Michael, Kadima (IL); Shlomi Kringel, Hertzlia (IL); Gal Peleg, Ramat-Gan (IL); Ronen David, Hertzlia (IL)

Correspondence Address: SUGHRUE MION, PLLC, 2100 PENNSYLVANIA AVENUE, N.W., SUITE 800, WASHINGTON, DC, 20037, US

(73) Assignee: COMVERSE LTD.

(21) Appl. No.: 11/319,541

(22) Filed: Dec. 29, 2005

(51) Int. Cl. H04N 7/173

(52) U.S. Cl. 725/126

(57) ABSTRACT

An in-band gateway which enables TV operators having a narrow out-of-band return channel the capability of providing high bandwidth applications including voicemail, voice attachments, music on demand, and picture mail, by using the in-band channel and the out-of-band channel in parallel. The in-band gateway can receive multiple sources of multi-media and manage them, so that when subscribers demand high bandwidth service, the in-band gateway sends the information though the in-band channel and can also handle the streaming of data. The command for sending a high bandwidth content is requested by a client software running on a set-top box application or middleware through the out-of-band channel. The in-band gateway allows the operators to provide multimedia content using both the narrow out-of-band channel and the in-band channel.

### BACKGROUND OF THE INVENTION

1. Field of the Invention

The present invention relates generally to providing television (TV) operators that have a narrow out-of-band return channel capability the ability to use and provide high bandwidth applications (such as voicemail, voice attachments, music on demand, picture mail etc.) using an in-band channel and an out-of-band channel in parallel. More particularly, the present invention relates to an in-band gateway (ING) in a head-end that receives and manages multiple sources of multi-media, so that when subscribers demand a high bandwidth service such as opening a picture/audio attachment, the ING sends requested information though the in-band channel and also handles streaming of data such us audio.

2. Description of the Related Art

There are currently two available methods for sending requested high bandwidth multimedia content to a subscriber's set-top box upon the subscriber's request.

The first method is the sending of radio/music channels to digital television (DTV) subscribers. In this way the operator is using expensive encoders that convert the audio content to MPEG2 and the converted information is sent to the operator's multiplexer (MUX) in order to broadcast the content. In this first method, a DTV subscriber would select to hear a specific audio channel broadcasted by the operator. The subscriber's set-top box is then tuning to this channel such that the subscriber can hear the audio which is broadcasted on the tuned channel.

The audio channel is always transmitted to all subscribers in this first method. This is called broadcast/multicast communication. There is no possibility for the subscriber to demand the audio content to start from a specific point because such a demand would require the operator to broadcast many similar audio channels (unicasting), thus occupying an exceedingly large bandwidth. In order to enjoy real video on demand or real audio on demand, the operator must allocate a large bandwidth which would be prohibitively expensive.

In broadcast communication, information that is broadcast can include data, video and audio content. The information is carried on hybrid fiber coaxial (HFC) in the case of community access television (CATV), or satellite in the case of direct broadcast satellite (DBS). In both cases, the communication is half duplex, and information can be sent to the TV subscribers' set-top boxes but cannot be received from them. This method, which is called in-band channel broadcasting, is used for broadcasting programs, video channels, audio channels and data download of applications to the set-top boxes. Information that is sent through the in-band channel is broadcast to all subscribers.

The second method is the interactive DTV carousel. This technique is used in order to send high bandwidth information and content to the subscriber's set-top boxes upon demand. Interactive applications can be downloaded to the subscriber's set-top boxes through an in-band channel and content such as still picture can be broadcasted to all subscribers. The interactive carousel holds a number of applications (games, commercials, etc.) that rotate on the carousel in each cycle. When a specific application is available on the carousel, then others cannot be accessed until their turn is ready. Bandwidth is allocated to applications within the carousel, the applications being sent one after another. The carousel is bandwidth dependant and transmission rate dependant. In the second method, a DTV subscriber would request to play an interactive game. The set-top box is then tuned to the specific channel where the application starts to download to the set-top box. Once the download of the application is completed, the application can be executed.

When the interactive carousel needs to play an audio content, the interactive carousel can send data in two manners only:

1. sending the whole content (high bandwidth consumption and major latency time will occur upon a subscriber's demand of content)

2. sending the content in packets—but this will cause jitter problems, due to the lack of control and monitoring of the timing and synchronization (the carousel is not accurate enough—a 1 millisecond resolution is needed in order to avoid jittering problems when streaming audio, however, the carousel is only accurate up to at most 100 ms).

The carousel also causes long latency time and late response time, due to the affect on the carousel from the allocated bandwidth and the rate of data transmission. Another parameter that affects the latency and response time is the number of concurrent sessions the carousel handles. Also, to the reason that the bandwidth allocated to the carousel is fixed, the carousel suffers from lack of flexible bandwidth management. The broadcasted content can be managed only after the carousel has completed a full round.

The prior art is not capable of streaming voice, audio or video to set-top boxes using existing interactive carousels. The carousel can only download data as static information to the set-top box, and cannot presently stream video and audio content to set-top boxes. The only way streaming to set-top boxes is possible is through use of expensive encoders that handle audio and video channels, but even in this case, the information is broadcasted and received by all set-top boxes. Encoders can handle streaming of voice and audio to the set-top box (as in radio channels). However, even with use of expensive encoders that handle audio and video channels, there is still not provided a way of unicasting (sending the information to a specific subscriber) information and in a real-time on-demand technique.

### SUMMARY OF THE INVENTION

The present invention has been made in order to solve the above drawbacks and other problems in the art.

An aspect of the present invention is to allow for streaming of voice and audio to a set-top box upon an on-demand request for any interactive application running on the set-top box. The information can be sent unicast/multicast instead of being broadcasted to all subscribers.

Another aspect of the present invention is to provide TV operators that have a narrow out-of-band return channel with the capability of providing high bandwidth applications (such as voicemail, voice attachments, music on demand, picture mail, etc.) using the in-band channel and the out-of-band channel in parallel.

The ING can receive multiple sources of multi-media and manage them, so when subscribers demand a high bandwidth service (such as opening a picture/audio attachment), the ING of the present invention sends the information though the in-band channel and in cases where streaming is needed (such us audio), the ING is also able to handle such requirements. The command for sending a high bandwidth content is requested by a client software running on the middleware of a specific set-top box through the out-of-band channel. The out-of-band return channel may be of different types, including cable, PSTN, DSL, RF, etc. The command may be requested through such as a digital subscriber line (DSL) with the set-top box being equipped with DSL for the out-of-band return channel, or through a modem in the case of DBS.

Another aspect of the present invention relates to TV/Cellular convergence, in which the ING is a key component in the Push2Show system. By allocating enough bandwidth, the ING can retrieve incoming streamed video from mobile handsets, transcode the streamed video in real-time and stream the transcoded video to the set-top boxes.

A further aspect of the present invention solves the problem of DBS operators that have low bit rate modems installed on the set-top boxes used by their subscribers and allows the operators to provide multimedia using both the narrow out-of-band channel (modem connection/RF connection—ALOHA protocol) and the in-band channel.

According to an exemplary embodiment of the present invention there is provided a system which receives and manages multiple sources of multi-media data, the system comprising: a set-top box which executes an interactive client application; content sources which provide desired content; an in-band gateway which receives the desired content provided by said content sources; and a multiplexer which broadcasts the desired content received by said in-band gateway to said set-top box through an in-band channel; wherein the desired content is requested by said set-top box through an out-of-band channel, and said in-band gateway sends tuning information through the out-of band channel to said set-top box to tune said set-top box to a proper channel for receiving the broadcasted desired content.

According to another exemplary embodiment of the present invention, the system may further comprise a transcoding server which converts the desired content to MPEG2 format prior to sending the desired content to said in-band gateway.

According to yet another exemplary embodiment of the present invention, there is provided a method of providing high bandwidth applications to a subscriber, wherein an in-band gateway receives and manages multi-media data, the method comprising: requesting high bandwidth multi-media data supplied by the in-band gateway; and sending the high bandwidth multi-media data to the subscriber through an in-band channel; wherein said high bandwidth multi-media data is requested through an out-of-band channel.

According to still yet another exemplary embodiment of the present invention, the method may further comprise sending tuning information through the out-of-band channel to a set-top box at the location of the subscriber for tuning the set-top box to a particular channel to receive the high bandwidth multi-media data sent to the subscriber through the in-band channel.

According to still yet another exemplary embodiment of the present invention, the method may further comprise returning back to a previously running application after the high bandwidth multi-media data has been received.

### BRIEF DESCRIPTION OF THE DRAWINGS

The above aspects and features of the present invention will be more apparent by describing exemplary embodiments of the present invention with reference to the accompanying drawings, in which:

FIG. 1 is a diagram of a system using an ING according to an exemplary embodiment of the present invention;

FIG. 2 is a block diagram of the ING according to an exemplary embodiment of the present invention;

FIG. 3 is a high-level Media Gateway architecture and key interface points according to an exemplary embodiment of the present invention; and

FIG. 4 is a flow diagram showing the principal operation performed by the ING according to an exemplary embodiment of the present invention.

### DETAILED DESCRIPTION OF EXEMPLARY EMBODIMENTS

Exemplary embodiments of the present invention will be described in greater detail with reference to the accompanying drawings.

The ING according to exemplary embodiments of the present invention utilizes an out-of-band channel to send tuning information to a particular set-top box with which particular content has been requested. The content is then delivered through the in-band channel to a user which requested the content.

The ING converts media carried on internet protocol (IP) networks into compatible formats for digital set-top boxes on an MPEG network. Unlike the MPEG media casting products of the prior art, the ING pulls media upon user demand and operates with low-latency.

This capability can be used for various applications, including:

voice mail (VM) retrieval and playback on the TV

VM screening

Internet Radio

converting graphics for TV display (MMS to TV)

Internet Video

Multiple system operators (MSOs) can use the ING to cross-market other broadband products with their digital video service. For example, the ING can be used to cross-market and differentiate the MSO's telephone services and digital video service.

Exemplary embodiments of the present invention provide the following:

(1) dynamic allocation of bandwidth for each channel;

(2) management of multiple and different channels;

(3) handling of different kinds of multimedia content;

(4) dynamic allocation of data packets broadcasted;

(5) solving the problems of the carousel and the encoder, in particular, providing:
a. the capability to stream voice/audio/video to the set-top boxes;
b. the capability of unicasting (sending the information to a specific subscriber) information enabling a real-time on-demand method;
c. shortening latency time and late response time for the subscribers; and
d. flexible bandwidth management; and

(6) indifference/transparent to the middleware running on the set-top box.

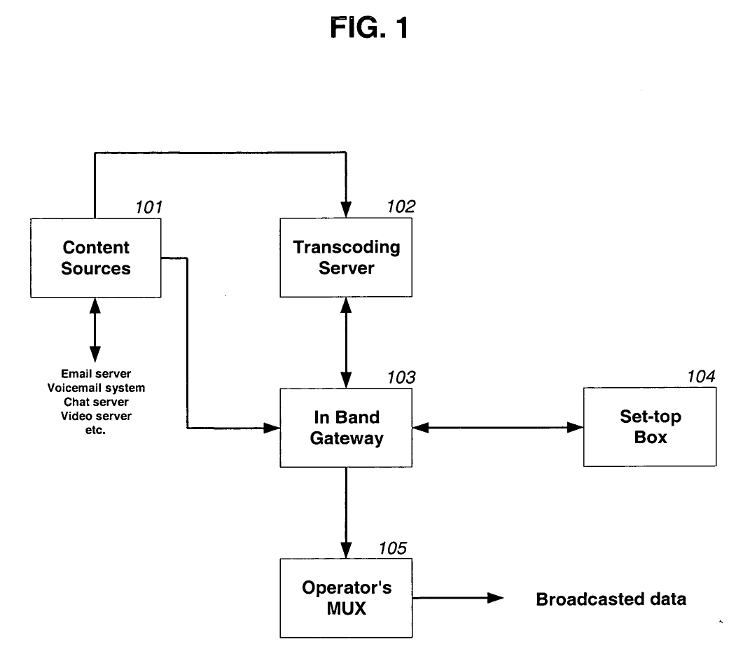

FIG. 1 is a diagram of a system using an ING according to an exemplary embodiment of the present invention.

Referring to FIG. 1, an interactive client application may be run by a DTV user on set-top box (104). The client application can provide the user an access to his email messages, picture mail or any other content related applications. Content is provided to the ING (103) by content sources (101), and may be content related to an email server, voicemail system, chat server or video server, but is not limited to these exemplary sources. If the user reads an email containing an attachment (picture or audio), once the user has selected to open this specific attachment on his TV, the content can be sent from the content sources (101) to two different paths:

(1) to a transcoding server (102), in a case where the attachment is not in MPEG2 format; or

(2) directly to the ING (103), in a case where the attachment is in MPEG2 format.

In the case where the content is not in MPEG2 format, the transcoding server (102) converts the content provided by the content sources (101) to MPEG2 format and sends the converted content to the ING (103).

In a parallel operation, the ING (103) sends to the set-top box (104) a service ID and track ID or packet identifier (PID) that the client application uses in order to tune to a proper channel and receive the content.

The ING (103) manages the content, configures an appropriate channel (audio, video or data), and sends the content to an operator's MUX (105). The content sent to the MUX (105) is broadcasted by the operator to the subscriber's set-top boxes and received by the specific set-top box that tunes to the channel number which had been sent earlier by the ING (103), and the attachment is presented and/or played to the DTV subscriber.

Once the DTV subscriber has finished watching and/or hearing the attachment, he can select to return back to the previously running application, and the client application tunes back to the last channel that the DTV subscriber was using before opening the attachment.

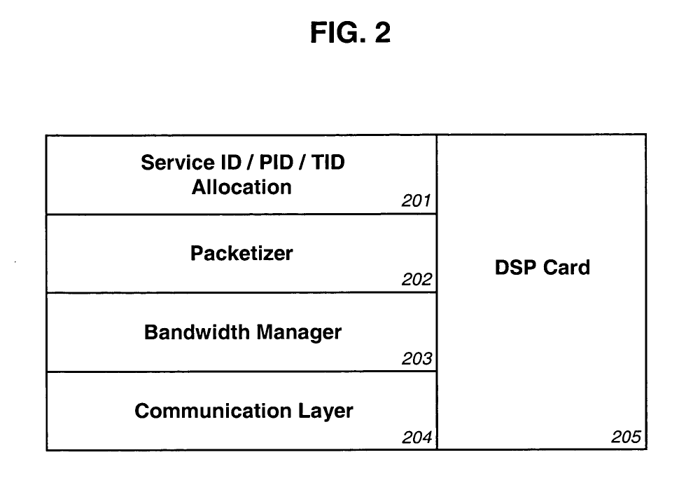

FIG. 2 is a block diagram of the ING of a head-end according to an exemplary embodiment of the present invention. Referring to FIG. 2, the ING requires input from the operator of the head end/gateway and defines parameters for allocation and range of service IDs/PIDs/table identifiers (TIDs), and allocation of bandwidth.

The information that is being used as an input for the ING is pure data or MPEG2 format—raw data.

Depending on the middleware being used by the set-top box, the client application requests and receives the following parameters from the ING:

Service ID+Track ID

PID

TID

These parameters are determined by the service ID, track ID, TID and PID allocation (201), which are part of a transport stream.

The packetizer (202) packages the MPEG2 raw data with a packetized elementary stream (PES) and generates packets in the size of 188 bytes each with PID. Once the packetizer (202) generates the PES, the packetizer (202) starts sending buffers to a DSP card (205) of the ING in order to convert it to a digital video broadcasting-asynchronous serial interface (DVB-ASI) stream. The DSP card (205) receives multiple MPEG data sources and generates and assembles an ASI transport stream, which communicates with the head-end equipment. The ASI transport stream may include service ID, PID, TID, and/or track ID coordinates. With a channel ID and track ID, tuning to a PID is possible. The packetizer (202) and bandwidth manager (203) also aid in assembling the ASI transport stream.

In the case that the packetizer (202) packages the content with service ID, the packetizer (202) generates a program map table (PMT) that contains the audio channel and the program clock reference (PCR) channel.

In packaging data, the packetizer (202) generates a DVB table similar to the DVB-ASI format (also called private section) and sends the DVB table to the DSP card (205). Video content can be packetized similar to audio or like data.

Once the DSP card (205) obtains information from multiple sources of MPEG streams, it generates in its output a DVB-ASI transport stream that can be sent to the operator's MUX (105) for broadcasting to the set-top boxes.

During this whole process, the bandwidth manager (203) controls the DSP card (205) on the required bandwidth and bit-rate for each specific channel. The DSP card (205) adds PCR to the received data, which enables the set-top box to play audio.

The DSP card (205) can also fix the PES time stamp, to be compatible with the PCR. This prevents jittering problems when playing audio. The communication layer (204) is used to send tuning information to the particular set-top box as described. The communication layer (204) interfaces and communicates with the client application running on the set-top box using the out-of-band channel, the transcoding server (102), and with the operator's MUX (105).

In a case the client application receives PID from the ING, the operator's MUX (105) performs demultiplexing on the content managed by the ING (103) to demultiplex the PID as a video or an audio and sends it to the set-top box MPEG decoder component, so the content can be played or presented.

In a case of receiving data, the demultiplexing is performed according to the PID and TID parameters and the data can be decoded.

In a case the client application receives service ID with track ID, the client application can tune to the specific service ID and track ID and the audio/video is handled by being played or presented.

In some middleware, it is possible to perform the demultiplexing of data also. Certain set-top boxes, when they tune to different channels, may terminate the current application running on the set-top box. This problem can be handled by the operator as a requirement to the electronic program guide (EPG) vendor to block this problem and to prevent termination of the current application. The middleware of the set-top box may be configured so as not to reset a current application when an application tries to tune the set-top box to a new channel.

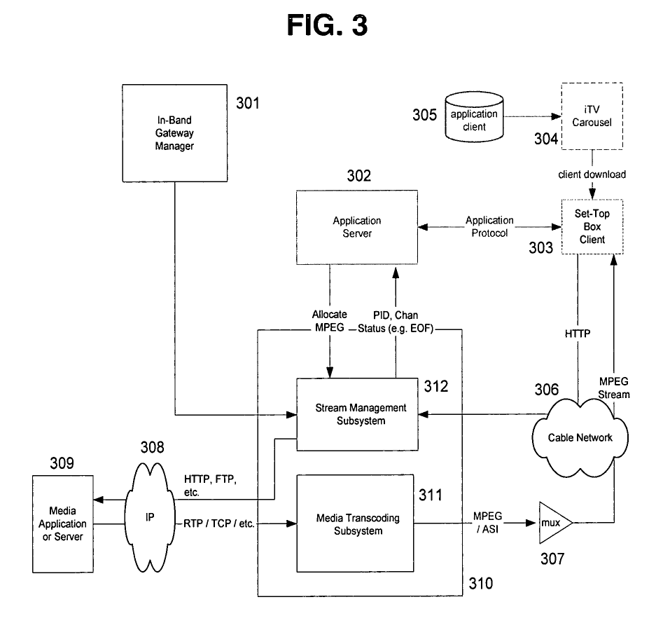

FIG. 3 is a high-level Media Gateway architecture and key interface points according to an exemplary embodiment of the present invention.

Referring to FIG. 3, the cable network (306) transcodes application-specific media that are hosted on IP network servers into a compatible format and transports for rendering on the digital set-top box. The in-band gateway manager (301) manages the following:

the MPEG selectors for each set-top box session,

the bandwidth and quality of service (QoS) for the specific application, and

the overall bandwidth management for the physical channel(s).

The client software is application specific. The set-top box client (303) interacts with the application server (302) to begin setting up a media session. The application server (302) in turn interacts with the in-band gateway manager (301) to retrieve stream locator information. The locator is then returned to the set-top box client (303), which tunes to the given locator and begins receiving the MPEG stream from the in-band gateway manager (301).

The application server (302) may include software provided by the MSO and works cooperatively with set-top box client software to receive a client download from application client (305) through iTV carousel (304). The application server (302) on a server side delivers client-server applications, whereby on a client side, the client-server applications can be loaded by the set-top box directly from the iTV carousel (304). By one example, in a case of using an e-mail application, an e-mail viewer is on the client side and the application server (302) is embodied as an e-mail server. The application server (302) interacts with the ING (310) which includes a stream management subsystem (312) and a media transcoding subsystem (311). A cable network (306) is a medium on which television content is delivered to home users, and may be a satellite with dishes or a network of cables to a home. The cable network (306) operates as a broadcast network.

The cable network (306) and the multiplexer (307) each include standard equipment which typically reside in the Head End of the cable or satellite operator. However, the components included in the cable network (306) and the multiplexer (307) may vary according to the operator by its special network topology.

Within the ING (310), the media transcoding subsystem (311) converts the media format and packaging from an IP stream of a file, such as .wav or .mp3 files, to the format and packaging used in the cable network (306), for example, an MPEG2 transport stream. The stream management subsystem (312) manages the resources of the media transcoding subsystem (311) and the bandwidth resource of the system. The stream management subsystem (312) also communicates with the application server (302) and enables the application server (302) to control the ING (310).)

The application server (302) interacts with the ING (310) to allocate MPEG resources on behalf of the client. The application server (302) first requests an MPEG locator from the in-band gateway manager (301) for the given media type. The transcoding and MPEG resources are then reserved by the in-band gateway manager (301), and the MPEG locator information is returned to the application server (302). The application server (302) communicates the locator information back to the client.

The media application or server (309) supplies stored or “live” media sources. Examples of stored media sources include video or graphic archives stored in the network. Voicemail systems are another example of stored media. Examples of live media sources include a public switched telephone network (PSTN) media gateway for live calls, or a 3-way bridging device for VM screening.

A stream from a media source in an IP network (308) is defined by three different parameters:

Media Type and format—.JPG, GIF, MP3, G.711, etc.;

Session protocol—HTTP, SIP, etc.; and

Transport protocol—TCP, RTP, RTSP, etc.

The ING (310) can interface with any number of media servers over the IP network (308) using FTP, RTP, RTSP, HTTP, etc. The exact method depends upon the specific application and media server. Different media types and corresponding protocols are shown in Table 1.

TABLE 1

| Media types | Session Protocol | Transport protocol |
|---|---|---|
| Graphics, data files | FTP | TCP |
| (.jpg, .gif, .xml, etc.) | | |
| Speech files G.711 | SIP | RTP |
| Music files MP3 | HTTP | TCP |

The in-band gateway manager (301) receives a URL from the client application to open a session and begin the media flow back to the set-top box. For applications where the session with the media application or server (309) is established by the application server (302) (e.g. session initiation protocol (SIP)), the in-band gateway manager (301) can be augmented to support a third-party media control protocol similar to media gateway control protocol (MGCP).

The ING (310) outputs MPEG/ASI data which is multiplexed by MUX (307). The MUX (307) then outputs broadcasted data to the cable network (306). The MPEG2/ASI data output from the ING (310) is compatible will all digital TV networks.

An exemplary embodiment of the cable network (306) is an HFC. However, in another exemplary embodiment of the present invention, the cable network (306) may alternatively be a DBS satellite network which includes an ING, in which the DBS receives broadcasted media by a set-top box.

External interfaces to the in-band gateway are shown in Table 2.

TABLE 2

| External Element | Purpose | Method |
|---|---|---|
| Application Server | Create and control sessions between the | XML/HTTP |
| | In-Band Gateway Manager and Set-Top | |
| | Box Client | |
| Media Server/Store | Establish Session with source for | Varies. Examples |
| (Session) | streaming to Set-Top Box Client. | include: |
| | Source could be photoalbum, voicemail, | SIP - via app |
| | etc. | server |
| | | HTTP - via In- |
| | | Band Gateway |
| | | Manager |
| Media Server/Store | Stream the media from server to Set- | Varies. Examples |
| (Media & Transport) | Top Box Client. | include: |
| | | Media |
| | | G.711 Audio |
| | | MP3 Audio |
| | | .JPG/.GIF |
| | | graphics |
| | | Etc. |
| | | Transport |
| | | RTP |
| | | RTSP |
| | | TCP |
| Set-Top Box Client | Establish session between Set-Top Box | Control: HTTP |
| | and In-Band Gateway Manager and then | Media: MPEG |
| | stream the media from the In-Band | Transport. Content |
| | Gateway Manager to the Set-Top Box. | type and media format |
| | | varies. |
| | | Video |
| | | Audio |
| | | Data |
| Administration and | Configure the In-Band Gateway | XML/TCP |
| Management | Manager for specific MPEG parameters | |
| | including: | |
| | Physical channels | |
| | PIDS | |
| | Bandwidth | |
| | Configure the In-Band Gateway | |
| | Manager for media transcoding | |
| Administration and | Fault management and performance | SNMP |
| Management | counters. | |

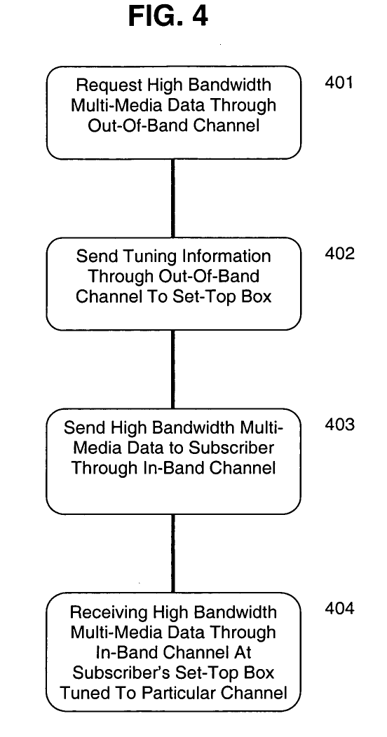

FIG. 4 is a flow diagram showing the principal operation performed by the ING according to an exemplary embodiment of the present invention.

Referring to FIG. 4, high bandwidth multi-media data is requested by a subscriber through an out-of-band channel (401). Tuning information is then sent through the out-of-band channel to a set-top box (402). The requested high bandwidth multi-media data is then sent to the subscriber through an in-band channel (403). The high bandwidth multi-media data sent through the in-band channel is received by the subscriber at the set-top box tuned to a particular channel for reception (404).

The foregoing exemplary embodiments and advantages are merely exemplary and are not to be construed as limiting the present invention. The present teachings can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A system which receives and manages multiple sources of multi-media data, the system comprising:
a set-top box which executes an interactive client application;
content sources which provide desired content;
an in-band gateway which receives the desired content provided by said content sources; and
a multiplexer which broadcasts the desired content received by said in-band gateway to said set-top box through an in-band channel;
wherein the desired content is requested by said set-top box through an out-of-band channel, and said in-band gateway sends tuning information through the out-of band channel to said set-top box to tune said set-top box to a proper channel for receiving the broadcasted desired content.

2. The system of claim 1, further comprising:
an application server which delivers client-server applications and further controls said in-band gateway.

3. The system of claim 2, wherein the client-server applications are loaded by said set-top box directly from an iTV carousel.

4. The system of claim 1, wherein said in-band gateway further comprises:
a media transcoding subsystem which converts a media format and packaging from an IP stream of a file included in the provided desired content to an MPEG2 transport stream; and
a stream management subsystem which manages resources of said media transcoding subsystem and manages bandwidth resources of the system.

5. The system of claim 1, further comprising:
a transcoding server which converts the desired content to MPEG2 format prior to sending the desired content to said in-band gateway.

6. The system of claim 1, wherein the tuning information comprises a service ID, a track ID or a packet identifier, and the interactive client application uses the tuning information to tune to the proper channel.

7. The system of claim 1, wherein said set-top box returns back to a previously running application after the broadcasted desired content has been received, by tuning said set-top box to the last channel used prior to the request for the desired content.

8. The system of claim 1, wherein the out-of-band channel is a cable, PSTN, DSL or RF return channel.

9. A method of providing high bandwidth applications to a subscriber, wherein an in-band gateway receives and manages multi-media data, the method comprising:
requesting high bandwidth multi-media data supplied by the in-band gateway; and
sending the high bandwidth multi-media data to the subscriber through an in-band channel;
wherein said high bandwidth multi-media data is requested through an out-of-band channel.

10. The method according to claim 9, wherein the requested high bandwidth multi-media data supplied by the in-band gateway is obtained from a stored or live media source.

11. The method according to claim 9, wherein the high bandwidth multi-media data is streamed to the subscriber.

12. The method according to claim 9, wherein a request for said high bandwidth multi-media data is sent by a client software.

13. The method according to claim 12, wherein the client software operates on middleware of a set-top box at a location of the subscriber.

14. The method according to claim 9, further comprising:
sending tuning information through the out-of-band channel to a set-top box at the location of the subscriber for tuning the set-top box to a particular channel to receive the high bandwidth multi-media data sent to the subscriber through the in-band channel.

15. The method according to claim 14, further comprising: returning back to a previously running application after the high bandwidth multi-media data has been received.
